(19) United States
(12) Patent Application Publication
(10) Pub. No.: US 2006/0100764 A1
(43) Pub. Date: May 11, 2006

(54) ADJUSTABLE AUTOMOTIVE CENTER CONSOLE

(76) Inventors: Robert J Adams, Ypsilanti, MI (US); Michael W Cass, Lenox, MI (US); Todd L DePue, Brighton, MI (US); Kenneth William Paul Shaner, Howell, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/904,385

(22) Filed: Nov. 8, 2004

(51) Int. Cl. G06F 7/00; E05F 15/00

(52) U.S. Cl. 701/49

(57) ABSTRACT

An automotive center console is adjustable in fore and aft directions. In one embodiment, the console includes a console housing slidably mounted within the vehicle interior and a controllable damper having high and low damping states. In the high damping state, the controllable damper maintains the console housing in a selected position. When it is desired to relocate the console housing to a new position, the controllable damper is actuated to the low damping state, whereby the console housing may be freely moved to the desired position. The controllable damper is actuated back to the high damping state to maintain the console housing in the new position.

### CROSS-REFERENCE

The present invention is related to U.S. patent application Ser. No. ______ [Attorney Docket No. MASL-70] and U.S. patent application Ser. No.______ [Attorney Docket No. MASL-72], filed on even date herewith.

### FIELD OF THE INVENTION

The present invention relates generally to vehicle interior components, and more particularly to an adjustable automotive console.

### BACKGROUND OF THE INVENTION

Automotive interiors are provided with various features and components to improve the comfort and convenience to vehicle occupants. For example, automobile interiors are commonly outfitted with a center console positioned between the front seats. The console includes various features such as an armrest, storage bays and storage compartments, cup and coin holders, and other features for improving the comfort and convenience of the vehicle. One drawback of conventional, center consoles is that they are not adjustable to accommodate different positions which may be preferred by individual occupants. In particular, center consoles are not typically adjustable in cooperation with the adjustable front seats. To overcome this drawback, some center consoles have been configured to permit limited adjustment in fore and aft directions to better accommodate positions desired by occupants and to correspond with the fore and aft adjustability of the front seats. Conventional adjustable center consoles, however, typically utilize adjustment mechanisms that permit adjustment to only discrete, predetermined positions. These mechanisms provide only limited adjustability of the center console and the transition to the discrete positions is not smooth.

A need therefore exists for an adjustable center console that addresses these and other drawbacks of the prior art.

### SUMMARY OF THE INVENTION

The present invention provides a center console that may be selectively, infinitely adjusted to any position within the range of fore-aft movement of the console. In one embodiment, the console includes a console housing that is slidably mounted within the vehicle interior for movement in the fore-aft direction. A controllable damper is coupled to the console housing to facilitate selectively positioning the console housing, and to maintain the console housing at the selected position.

The controllable damper has high and low damping states. In the high damping state, the damper resists movement of the console housing so that the position of the console within the interior of the vehicle is maintained. When it is desired to reposition the console, such as to correspond with a repositioned location of at least one of the front seats, for example, the controllable damper is actuated from the high damping state to the low damping state. In the low damping state, the console housing can be freely moved to a new position. The controllable damper is then actuated back to the high damping state to maintain the console housing in the new position.

In another embodiment, the controllable damper is a magneto-rheological damping having a fluid that is responsive to an applied magnetic field to vary the apparent viscosity of the fluid. A permanent magnet associated with the magneto-rheological damper produces a magnetic field that maintains the damper in the high damping state without requiring power to be supplied to the damper. The console further includes a wire coil proximate the permanent magnet and configured to create a second magnetic field that substantially negates the magnetic filed of the permanent magnet when current is supplied to the wire coil. When the wire coil is energized, the apparent viscosity of the fluid decreases to correspond to the low damping state. By energizing and de-energizing the wire coil, the magneto-rheological damper can be actuated between the high and low damping states.

In yet another embodiment, the console further includes a switch and a controller communicating with the controllable damper to facilitate actuating the damper to and between the high and low damping states. When the switch is activated by a vehicle occupant, the controller actuates the controllable damper from the high damping state to the low damping state so that that the console housing can be repositioned. When the switch is released, or alternatively activated a second time, the controller actuates the damper from the low damping state to the high damping state to maintain the console housing at the selected position.

The features and objectives of the present invention will become more readily apparent from the following Detailed Description taken in conjunction with the accompanying drawings.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of an automotive interior, including an exemplary center console according to the present invention; and

FIG. 2 is a perspective view depicting detail of the center console of FIG. 1.

### DETAILED DESCRIPTION

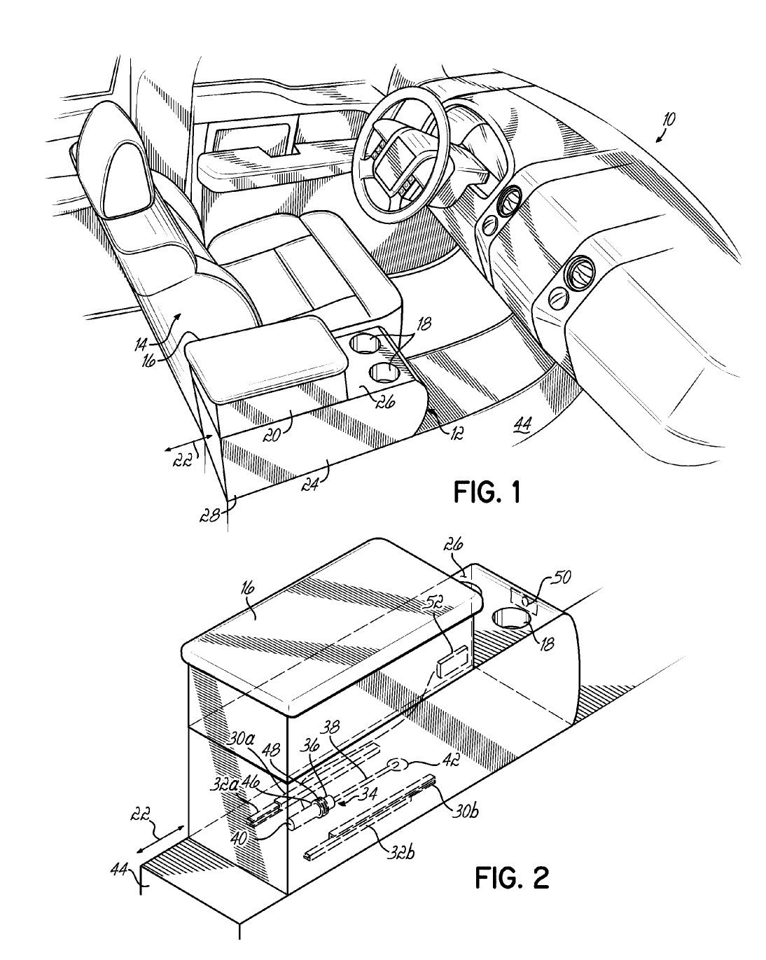

FIG. 1 depicts an automotive interior 10, including an exemplary center console 12 according to the present invention. The center console 12 is positioned between the front seats 14 (only one shown) and is provided with an armrest 16, cup holders 18, and a storage compartment 20, as known in the art. The center console 12 is slidably adjustable within the interior 10 of the vehicle, in fore and aft directions, as indicated by arrow 22, so that the position of the center console 12 may be conveniently located relative to the front seats 14 and the armrest 16, cup holders 18, storage compartment 20, or other features of the center console 12 may be placed within convenient reach of the vehicle occupants.

Referring now to FIG. 2, various features of the center console 12 are described in more detail. The center console 12 includes a console housing 24 having upper and lower surfaces 26, 28. The armrest 16, cup holders 18 and other accessories are generally mounted proximate the upper surface 26 of the housing 24. A pair of spaced-apart slide brackets 30a, 30b are provided on the bottom surface 28 of the console housing 24, generally along the longitudinal sides thereof. The slide brackets 30a, 30b slidingly engage corresponding elongate rails 32a, 32b fixed to the floor 44 of the vehicle interior so that the console housing 24 can be selectively positioned along the rails 32a, 32b in the fore and aft directions 22 within the interior 10 of the vehicle. A controllable damper 34 is disposed adjacent the bottom surface 28 of the console housing 24 and cooperates with the slide brackets 30a, 30b and rails 32a, 32b to maintain the console housing 24 at the selected position along the rails 32a, 32b.

In the embodiment shown, the controllable damper 34 is a linear damper including an elongate tubular damper housing 36 and a piston rod 38 slidably and extensibly coupled to the damper housing 36, as known in the art. A first end 40 of the damper 34 is secured to the console housing 24, and a second end 42 of the damper 34 is secured to the vehicle interior structure, such as the floor pan 44. The controllable damper 34 may be actuated to and between high and low damping states. In the low damping state, the console housing 24 may be slidably moved along the rails 32a, 32b to a desired fore-aft position. When the damper 34 is in the high damping state, the console housing 24 is fixed in position with respect to the vehicle interior 10. The controllable damper 34 may alternatively be actuated to an intermediate damping state, between the high and low damping states, to control the resistance to movement of the console housing 24 between selected positions. In this manner, the “feel” of the movement of the console housing 24 may be tuned to provide aesthetically pleasing performance, as may be desired.

In one embodiment, the controllable damper 34 is a magneto-rheological damper having a fluid that is responsive to an imposed magnetic field to increase the apparent damping of the fluid, as known in the art. The magnetic field is provided by a permanent magnet 46 associated with the controllable damper 34 and configured to provide a magnetic field without requiring power to be supplied to the damper 34. The magnetic field is sufficient to increase the apparent viscosity of the fluid such that the console housing 24 cannot be displaced from the selected position.

The controllable damper 34 further includes a wire coil 48 positioned adjacent the permanent magnet 46. When it is desired to reposition the console housing 24, an electric current from a power source (not shown) is supplied to the wire coil 48 to create a second magnetic field that is approximately equal and opposite to the magnetic field produced by the permanent magnet 46. The second magnetic field substantially negates the magnetic field provided by the permanent magnet 46 such that the apparent viscosity of the fluid is reduced and the controllable damper 34 is thus actuated to the low damping state.

With the damper 34 in the low damping state, the console housing 24 may be slidably adjusted along the rails 32a, 32b, in the fore-aft direction 22, to a desired position. When the console housing 24 is located at the desired position the current to the wire coil 48 is stopped, whereby the magnetic field produced by the permanent magnet 46 causes the fluid to exhibit an apparent viscosity corresponding to the high damping state of the controllable damper 34.

In the embodiment shown, the adjustable console 12 further includes a switch 50 and a controller 52 communicating with the controllable damper 34 to permit vehicle occupants to selectively actuate the controllable damper 34 between the high and low damping states. The controller 52 may be configured, for example to provide electric current to the wire coil 48 associated with a magneto-rheological damper as described above when the switch 50 is activated by a vehicle occupant to thereby actuate the controllable damper 34 from the high damping state to the low damping state. The console housing 24 may then be selectively positioned within the vehicle interior 10 as described above. When the switch 50 is released, the controller 52 discontinues electric current to the wire coil 48 and the damper 34 is actuated to the high damping state such that the selected position of the console housing 24 is maintained until it is desired to again reposition the console housing 24.

Alternatively, the switch 50 and controller 52 may be configured to actuate the controllable damper 34 from the high damping state to the low damping state when the switch 50 is first activated by a vehicle occupant, and to actuate the damper 34 from the low damping state to the high damping state when the switch 50 is activated a second time by a vehicle occupant. While the switch 50 is shown herein as being located on a forward part of the console housing 24, adjacent the armrest 18, it will be recognized that the switch 50 may be located at various other positions with the vehicle interior 10.

While the exemplary embodiment shown and described above utilizes a linear, magneto-rheological damper, it will be recognized that other types of dampers, such as rotary dampers, electro-rheological dampers, or other types of controllable dampers may be used to maintain the center console 12 in a selected position at a high damping state, and to permit selective adjustment of the location of a center console 12 when the damper 34 is actuated to a low damping state.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

What is claimed is:

1. An adjustable automotive center console, comprising:
a console housing configured to be slidably mounted within the interior of an automobile; and
a controllable damper coupled to said console housing, said controllable damper actuatable between high and low damping states to facilitate positioning said console housing at a desired location after sliding movement thereof.

2. The console of claim 1, further comprising an armrest positioned atop said console housing for movement therewith.

3. The console of claim 1, wherein said controllable damper is a magneto-rheological damper.

4. The console of claim 1, further comprising a switch associated with said controllable damper, said switch operable to facilitate selective actuation of said controllable damper between said high and low damping states.

5. The console of claim 1, further comprising a controller associated with said controllable damper, said controller operable to actuate said controllable damper between said high and low damping states.

6. The console of claim 3, further comprising a permanent magnet associated with said magneto-rheological damper and configured to maintain said high damping state when no power is supplied to said damper.

7. The console of claim 6, further comprising:
a wire coil associated with said permanent magnet and configured to substantially negate a magnetic field produced by said permanent magnet when current is supplied to said wire coil to actuate said magneto-rheological damper from said high damping state to said low damping state.

8. A method of adjusting the position of a center console of an automobile, the console including a console housing slidably mounted within the interior of the automobile and a controllable damper coupled to the console housing, the method comprising:
actuating the controllable damper from a high damping state to a low damping state;
sliding the console housing to a desired position within the interior of the automobile; and
actuating the controllable damper from the low damping state to the high damping state such that the console housing is maintained in the adjusted positioned by the controllable damper.

9. The method of claim 8, wherein the controllable damper is a magneto-rheological damper.

10. The method of claim 9, wherein the console further includes a permanent magnet associated with the magneto-rheological damper, and wherein the magneto-rheological damper is actuated to the high damping state using the permanent magnet.

11. The method of claim 10, wherein the console further includes a wire coil associated with the magneto-rheological damper, the method further comprising:
supplying an electric current through the wire coil to substantially negate a magnetic field produced by the permanent magnet and thereby actuate the magneto-rheological damper from the high damping state to the low damping state.
